(19) United States
(12) Patent Application Publication
(10) Pub. No.: US 2025/0150904 A1
(43) Pub. Date: May 8, 2025

(54) DATA PATH CONTROL IN SEAMLESS ROAMING

(71) Applicant: Apple Inc., Cupertino, CA (US)

(72) Inventors: Pooya Monajemi, San Jose, CA (US); Ahmad Reza Hedayat, Carlsbad, CA (US); Chittabrata Ghosh, Fremont, CA (US); Jarkko L. Kneckt, Los Gatos, CA (US); Lochan Verma, Danville, CA (US); Morteza Mehrnoush, Hayward, CA (US); Oren Shani, Saratoga, CA (US); Veerendra Boodannavar, Cupertino, CA (US); Yong Liu, Campbell, CA (US); Zhou Lan, San Jose, CA (US)

(21) Appl. No.: 18/899,725

(22) Filed: Sep. 27, 2024

Related U.S. Application Data
(60) Provisional application No. 63/596,783, filed on Nov. 7, 2023.

(51) Int. Cl. H04W 36/00; H04W 36/02; H04W 36/08

(52) U.S. Cl. CPC H04W 36/0033; H04W 36/023; H04W 36/08

(57) ABSTRACT

Disclosed are methods, systems, and computer-readable medium to perform operations including: determining that a wireless device will switch from a first access point radio to a second access point radio; selecting pseudo-static context data for the wireless device communication with the first access point radio based at least on determining that the wireless device will switch from the first access point radio to the second access point radio; and transmitting, to the second access point radio, the pseudo-static context data a) while the wireless device continues at least some communication with the first access point radio and b) that indicates that the second access point radio will receive an instantaneous context for the wireless device.

### CROSS-REFERENCE TO RELATED APPLICATION

This application claims the benefit of U.S. Provisional Application No. 63/596,783, filed Nov. 7, 2023, the contents of which are incorporated by reference herein.

### BACKGROUND

Many electronic devices communicate with each other using wireless local area networks (WLANs), such as those based on a communication protocol that is compatible with an Institute of Electrical and Electronics Engineers (IEEE) standard, e.g., the IEEE 802.11 standard (also known as “Wi-Fi”). A WLAN typically includes an access point that provides one or more stations (STAs), e.g., wireless devices, with access to another network, such as the Internet. There are many generations of the IEEE 802.11 standard, including 802.11ax (Wi-Fi 6) and 802.11be (Wi-Fi 7).

IEEE 802.11 is a packet-based protocol. Under this protocol, a transmitter, e.g., an access point (AP), packages control information or user data into a protocol data unit (PDU) in a physical layer convergence protocol (PLCP). The PLCP PDU (PPDU) includes a preamble and a data field, among other fields. After generating the PPDU, the access point can send the PPDU to a station connected to the access point. Communication from the access point to a station is referred to as the downlink, and the communication from a station to the access point is referred to as the uplink.

### SUMMARY

Wireless devices, e.g., using IEEE 802.11 wireless standards, can switch between access point radios for various reasons. This can include switching to change frequencies for a link between the wireless device and an access point or switching between access points, e.g., as the wireless device physically moves from the coverage area of one access point to another coverage area for another access point.

To enable the wireless device to switch between access point radios, the access points can communicate pseudo-static context information for the communication with the wireless device. The pseudo-static context information can enable the new access point radio to continue a communication session with the wireless device without requiring an initial handshake during which settings for the communication session are communicated. This exchange of pseudo-static context information occurs while the wireless device continues to communicate with the initial access point radio. To complete the transfer of communication to the second access point radio, the wireless device can synchronize its instantaneous context with the second access point radio after the exchange of pseudo-static context information occurs.

Given differences in data communication paths, the wireless device can initiate transfer of one communication path before the other. For instance, the wireless device can transmit uplink data to the second access point radio while continuing to receive downlink data from the initial access point radio.

In accordance with some aspects of the present disclosure, maintaining, for a wireless device, pseudo-static context data that comprises data with a first probabilistic change rate that does not satisfy a change rate threshold and is different data from instantaneous context data for the wireless device with a second probabilistic change rate that satisfies the change rate threshold; determining that the wireless device will switch from a first access point radio to a second access point radio; selecting at least some of the pseudo-static context data for the wireless device communication with the first access point radio based at least on determining that the wireless device will switch from the first access point radio to the second access point radio; and generating instructions for transmission, to the second access point radio while the wireless device continues at least some communication with the first access point radio, of the at least some of the pseudo-static context data.

In accordance with some aspects of the present disclosure, receiving, from a first access point radio and by a second access point radio and while a wireless device continues at least some communication with the first access point radio, pseudo-static context data that indicates that the wireless device will switch from the first access point radio to the second access point radio; and receiving, from the wireless device or the first access point radio, an instantaneous context at the time that the wireless device is completing the switch from the first access point radio to the second access point radio.

In accordance with some aspects of the present disclosure, generating instructions for transmission, from a wireless device, of a request to switch from a first access point radio to a second access point radio and that indicates that the first access point radio should transmit, to the second access point radio, pseudo-static context data for the wireless device communication with the first access point radio; reassigning, for one or more uplink frames from a plurality of uplink frames that includes one or more uplink frames transmitted to the first access point radio that have one or more first sequence numbers, one or more second sequence numbers to start from zero; and generating second instructions for transmission, to the second access point radio and based at least in part on the one or more second sequence numbers, of the one or more uplink frames.

In accordance with some aspects of the present disclosure, maintaining, in an uplink bitmap, one or more first sequence numbers for one or more uplink frames transmitted to a first access point radio; and selecting, as a first uplink frame in the one or more uplink frames, a frame represented by a first hole in the uplink bitmap.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations, determining that a wireless device will switch from a first access point radio to a second access point radio can include receiving, from the wireless device, a request to switch from the first access point radio to the second access point radio.

In some implementations, the method can include generating instructions for transmission, to the wireless device and after transmitting the pseudo-static context data, of one or more downlink frames.

In some implementations, the method can include receiving, from the wireless device, a request for a buffer status after a network downlink route switch from the first access point radio to the second access point radio; and generating instructions for transmission, to the wireless device, of a response that represents a quantity of buffered downlink frames remaining at the first access point radio.

In some implementations, the method can include updating a more data bit in the one or more buffered downlink frames to indicate that the first access point radio does not have additional buffered downlink frames and the wireless device should signal the second access point radio to start transmitting downlink frames to the wireless device. The more data bit can be in a last buffered downlink frame.

In some implementations, the more data bit is in a last buffered downlink frame.

In some implementations, the method can include determining, at the time that the wireless device is completing the switch from the first access point radio to the second access point radio, whether to generate second instructions for the transmission of the instantaneous context to the second access point radio.

In some implementations, the method can include generating second instructions for the transmission, to the second access point radio before completing the switch from the first access point radio to the second access point radio, of an uplink instantaneous context.

In some implementations, the method can include generating second instructions for the transmission, to the second access point radio after completing the switch from the first access point radio to the second access point radio, of a downlink instantaneous context.

In some implementations, generating instructions for transmission of the pseudo-static context data can include generating instructions for transmission, to the second access point radio, of the pseudo-static context data that indicates that the second access point radio will receive the instantaneous context from the wireless device at the time that the wireless device is completing the switch from the first access point radio to the second access point radio.

In some implementations, the first access point radio and the second access point radio can be included in the same access point.

In some implementations, the first access point radio and the second access point radio can be separately located access points.

In some implementations, the instantaneous context can be an explicit instantaneous context or an implicit instantaneous context.

In some implementations, the method can include determining, based at least on the instantaneous context, a packet number for transmissions to the wireless device; and generating instructions for transmission, based at least on the packet number, of one or more downlink frames to the wireless device.

In some implementations, the method can include determining, based at least on the pseudo-static context data, a packet number for transmissions to the wireless device; and generating instructions for transmission, based at least on the packet number, of one or more downlink frames to the wireless device.

In some implementations, receiving the pseudo-static context data can include receiving the pseudo-static context data from the first access point radio with a first multi-link device address and by the second access point radio with a second, different multi-link device address.

In some implementations, the method can include resetting a packet number for transmissions to the wireless device; and generating instructions for transmission, based at least on the packet number and a second, of different multi-link device address, one or more downlink frames to the wireless device.

In some implementations, the method can include maintaining, in an uplink bitmap, the one or more first sequence numbers for the one or more uplink frames transmitted to the first access point radio; and selecting, as a first uplink frame in the one or more uplink frames, a frame represented by a first hole in the uplink bitmap. The one or more uplink frames can be uplink frames for transmission to the second access point radio, can be associated with a bitmap, or both.

In some implementations, a last uplink frame from the one or more uplink frames can have a first packet number.

In some implementations, generating the second instructions for transmission of the one or more uplink frames can include generating the second instructions for transmission of the one or more uplink frames, the first of which has a second packet number that maintains packet number continuity based on the first packet number.

In some implementations, the second packet number can be the next packet number, sequentially, after the first packet number.

The subject matter described in this specification can be implemented in various implementations and may result in one or more of the following advantages. In some implementations, the systems and methods described in this specification can minimize latency, minimize or eliminate downlink data loss, or a combination of both. In some implementations, the systems and methods described in this specification can maximize wireless device, e.g., STA, control over timing, data handling, or both. These advantages can reduce or eliminate disruptions, glitches, or both, in the wireless device's operation, e.g., in an experience of an end user of the wireless device.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a block diagram of example electronic devices communicating wirelessly, according to some implementations.

FIG. 2 depicts an example environment in which a wireless device communicates with two access point radios.

FIGS. 3A-B depict example environments for a wireless device switching communication between access point radios given frame communication errors.

FIGS. 4A-B depict example environments in which a wireless device communicates with two access point radios.

FIG. 5 depicts an example environment in which a single radio wireless device communicates with two access point radios.

FIG. 6 illustrates a flowchart of an example method for using pseudo-static context data, according to some implementations.

FIG. 7 illustrates a block diagram of an example electronic device, according to some implementations.

### DETAILED DESCRIPTION

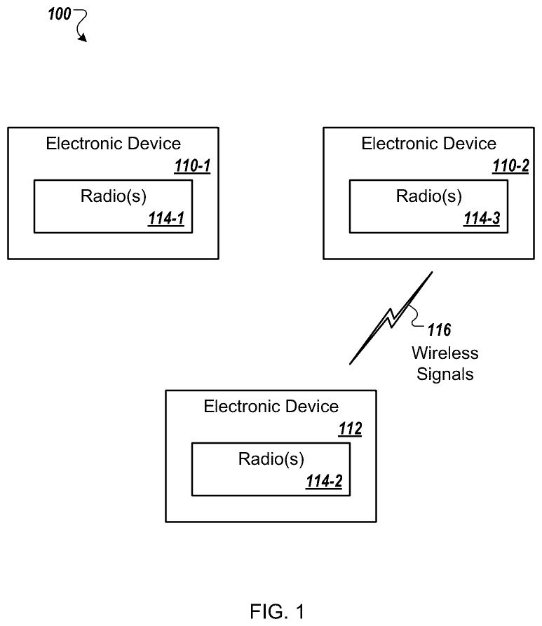

FIG. 1 illustrates a block diagram 100 of example electronic devices communicating wirelessly, according to some implementations. Notably, one or more electronic devices 110 (such as a smartphone, a laptop computer, a notebook computer, a tablet, or another such electronic device) and access point 112 can communicate wirelessly in a WLAN using an IEEE 802.11 communication protocol. Thus, electronic devices 110 can be associated with or can have a connection with access point 112. For example, electronic devices 110 and access point 112 can wirelessly communicate while: detecting one another by scanning wireless channels, transmitting and receiving beacons or beacon frames on wireless channels, establishing connections (e.g., by transmitting connect requests), and/or transmitting and receiving packets or frames (which can include the request and/or additional information, such as data, as payloads). Note that the access point 112 can provide access to a network, such as the Internet, via an Ethernet protocol, and can be a physical access point or a virtual or “software” access point that is implemented on a computer or an electronic device. In this specification, electronic devices 110 are sometimes referred to as “recipient electronic devices” or “receiver stations.”

Although the environment shown in FIG. 1 is provided as an example, in alternative implementations, different numbers and/or types of electronic devices can be present. For example, some implementations can include more or fewer electronic devices. As another example, in some implementations, different electronic devices can be transmitting and/or receiving packets or frames. In some implementations, multiple links can be used during communication between electronic devices 110.

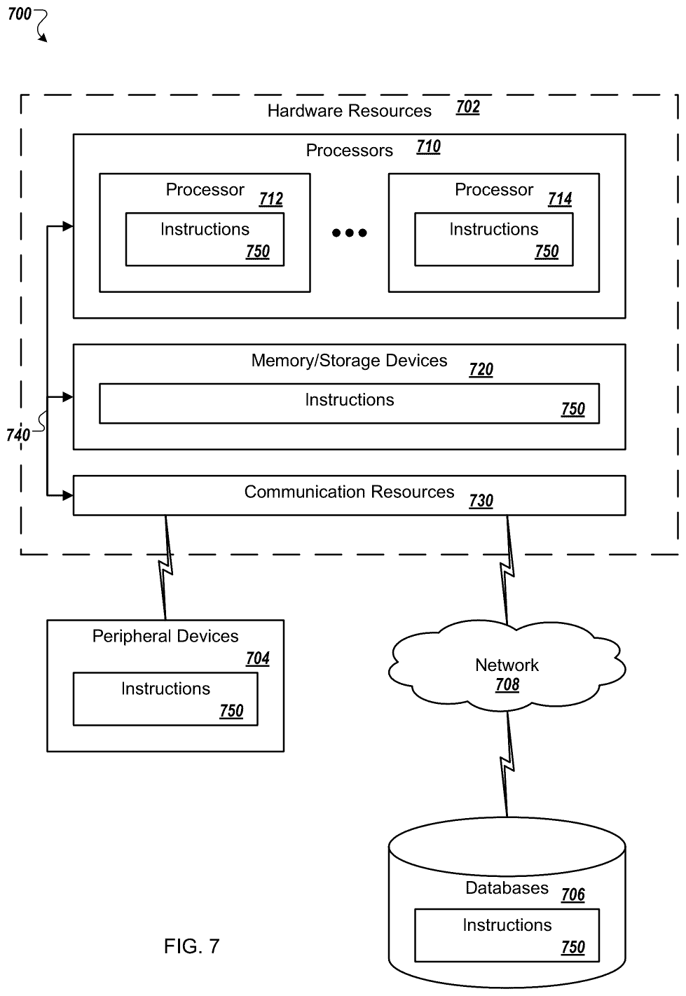

As described further below with reference to FIG. 7, electronic devices 110 and access point 112 can include subsystems, such as a networking subsystem, a memory subsystem, and a processor subsystem. In addition, electronic devices 110 and access point 112 can include radios 114 in the networking subsystems. More generally, electronic devices 110 and access point 112 can include (or can be included within) any electronic devices with networking subsystems that enable electronic devices 110 and access point 112, respectively, to wirelessly communicate with another electronic device. This can include transmitting beacons on wireless channels to enable the electronic devices to make initial contact with or to detect each other, followed by exchanging subsequent data/management frames (such as connect requests) to establish a connection, configure security options, transmit and receive packets or frames via the connection, etc.

As shown in FIG. 1, wireless signals 116 are communicated by one or more radios 114-1 and 114-2 in electronic device 110-1 and access point 112, respectively. For example, as noted previously, electronic device 110-1 and access point 112 can exchange packets or frames using a Wi-Fi communication protocol in a WLAN. Further, one or more radios 114-1 can receive wireless signals 116 that are transmitted by one or more radios 114-2 via one or more links between electronic device 110-1 and access point 112. Alternatively, the one or more radios 114-1 can transmit wireless signals 116 that are received by the one or more radios 114-2.

In some implementations, wireless signals 116 are communicated by one or more radios 114 in electronic devices 110 and access point 112, respectively. For example, one or more radios 114-1 and 114-3 can receive wireless signals 116 that are transmitted by one or more radios 114-2 via one or more links between the electronic devices 110-1 and 110-2, and the access point 112.

In some implementations, the access point 112 can group the electronic devices 110 into a target station set. The target station set concept comes from downlink multi-user transmission where the access point 112 can transmit to multiple stations simultaneously in one PPDU using Orthogonal Frequency Division Multiple Access (OFDMA) or multiuser (MU) Multiple Input Multiple Output (MU-MIMO). Here, the target station set is a set of stations that can simultaneously be served by the access point 112. The stations in the set do not need to share the same PHY parameters, such as MCS, number of streams, etc.

In some implementations, the access point 112 can simultaneously communicate with a plurality of electronic devices 110 using multiuser (MU) techniques, such as MU Multiple Input Multiple Output (MU-MIMO). In some implementations, the access point 112 communicates with the electronic devices 110 using frequency multiplexing such that the access point 112 allocates each of the electronic devices a portion of the overall bandwidth. For example, to simultaneously communicate with four electronic devices over an 80 Megahertz (MHz) bandwidth, the access point 112 transmits a MU-PPDU over the 80 MHz bandwidth. The MU-PPDU includes a sub-PPDU for each of the four electronic devices, where each sub-PPDU (or sub-channel) is allocated 20 MHz. The access point 112 can use the MU-PPDU to communicate with devices in the same target set, devices in different target sets, or a combination of both.

In some implementations, access point 112 and one or more electronic devices can be compatible with an IEEE 802.11 standard that includes trigger-based channel access, e.g., IEEE 802.11ax. In 802.11ax, Orthogonal Frequency Division Multiple Access (OFDMA) is used to enable simultaneous communications between the access point 112 and multiple electronic devices. OFDMA divides the available physical spectrum into multiple orthogonal sub-channels, or resource units (RUs), which can be allocated to different electronic devices (users). Under the standard, the access point 112 coordinates multiuser OFDMA by broadcasting a trigger frame which, among other things, allocates a RU to each participating electronic device. Each electronic device responds to the trigger frame by transmitting a PPDU to the access point 112 using the allocated RU. The trigger frame can also include power control information. The access point 112 can instruct all electronic devices 110 when to start and stop transmitting. Note that access point 112 and the electronic devices 110 can communicate with one or more legacy electronic devices that are not compatible with the IEEE 802.11 standard (i.e., that do not use multi-user trigger-based channel access).

In some implementations, processing a packet or frame in one of electronic devices 110 access point 112, or a combination of both, includes: receiving wireless signals 116 encoding a packet or a frame; decoding/extracting the packet or frame from received wireless signals 116 to acquire the packet or frame; and processing the packet or frame to determine information contained in the packet or frame (such as data in the payload).

As discussed previously, one or more of electronic devices 110 and access point 112 can communicate with each other. Notably, access point 112 can transmit a PPDU that includes a preamble and a data field. In some implementations, access point 112 can be configured to use concatenated PPDUs (C-PPDUs), e.g., for low latency communications with receiver stations. A C-PPDU includes a plurality of component PPDUs, each of which includes preamble and a data payload. As described in more detail below, the C-PPDU includes a plurality of component PPDUs. The first component PPDU is preceded by a first preamble called a “full preamble.” The remaining component PPDUs in the C-PPDU are each preceded by respective preambles that are shorter in length than the first preamble. In some implementations, the access point 112 might not perform contention or receive a block acknowledgement (BA) before the plurality of component PPDUs are transmitted.

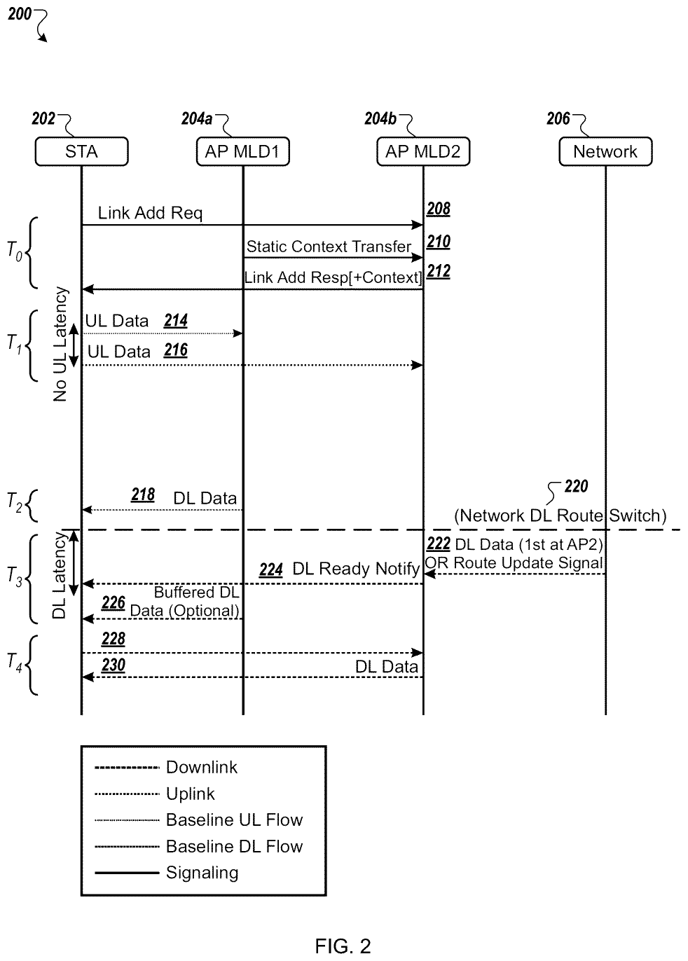

FIG. 2 depicts an example environment 200 in which a wireless device 202 communicates with two access point radios 204a-b. The two access point radios 204a-b can implement part of a network 206 to which the wireless device 202 connects. The network 206 can use the access point radios 204a-b to send data to, receive data from, or a combination of both, the wireless device 202 and optionally other devices (not shown).

In the environment 200, the network 206 might not be able to transmit certain types of data between the two access point radios 204a-b. For instance, the network might not be able to forward downlink data, uplink data, MAC service data unit (MSDU) data, or a combination of these, from one of the access point radios 204a-b to the other.

The two access point radios 204a-b can transmit other types of configuration data to each other. For instance, a first access point radio 204a can transmit context data to a second access point radio 204b, as described in more detail below.

In the environment 200, certain operations might have a non-negligible delay. For instance, transmission of a wireless device context might have a non-negligible delay. A network downlink route update might have a non-negligible delay. Various implementations described in this specification can be implemented to reduce one or both of these delays compared to other systems.

The wireless multi-link device 202, e.g., “STA”, is described with two links that can operate in either Simultaneous Transmit and Receive (“STR”) mode or enhanced multi-link single radio (“eMLSR”) mode. For instance, the wireless device 202 can include one main radio and use eMLSR mode. When the wireless device 202 includes two or more radios capable of operating in STR mode, the wireless device 202 can use the two links independently of each other.

As a result of the modes available to the wireless device 202, the wireless device 202 can use a first one of the two links with an origin access point (“AP”) multi-link device (“MLD”) radio and a second one of the two links with a destination AP MLD radio. This can enable the wireless device 202 to roam, e.g., seamlessly, from one AP MLD radio to another, e.g., given physical movement of the wireless device 202. While roaming between AP MLD radios, the environment 200 can preserve data continuity on uplink (“UL”), downlink (“DL”), or both. The environment 200 can enable the roaming with minimal latency, low, e.g., no, data loss, or a combination of both.

The access point radios 204a-b can be in any appropriate combination of devices. For instance, the first access point radio 204a can be in a first access point and the second access point radio 204b can be in a second, separately located access point. For instance, the access points can be an “AP MLD” that contains multiple links each of which is one AP.

Prior to time period T₀, the wireless device 202 can communicate with the first access point radio 204a. This communication can include the wireless device 202 transmitting uplink data to the first access point radio 204a. The communication can include the wireless device receiving downlink data from the first access point radio 204a.

During time period T₀, the wireless device 202 can transmit a link add request 208, or another signal to initiate the pseudo-static context transfer, to the second access point radio 204b. This request can indicate that the wireless device 202 is switching, e.g., roaming, from the first access point radio 204a to the second access point radio 204b.

In response, the second access point radio 204b can receive a static context transfer 210 from the first access point radio 204a, e.g., offline. This receipt can occur when the second access point radio 204b sends, to the first access point radio 204a, a signal that indicates that the wireless device 202 is switching between the two access point radios.

The static context transfer 210 can include any appropriate data. For instance, the static context transfer can include pseudo-static context data for the first access point radio's 204a communication with the wireless device 202. The pseudo-static context data can include security context data, time changing context data, or any other appropriate data. The pseudo-static context data can be data with a change rate, e.g., frequency, that does not satisfy a change rate threshold, e.g., infrequently, such that the pseudo-static context data will not likely change before the switch from the first access point radio 204a to the second access point radio 204b is complete. Some examples of security context data can include keys and passports, e.g., for devices. One example of time changing context data is a block acknowledgement (“BA”) agreement that includes a size of a block acknowledgement bitmap and its associated TID, e.g., without including the bitmap itself which would have a change rate that satisfies, or is likely greater than, the change rate threshold. Other time-changing data can be included in the context transfer with the prior knowledge that the data may change after the transfer, e.g., such as other types of block acknowledgement session parameters.

The second access point radio 204b can transmit, to the wireless device 202, a link add response, optionally with context data. The transmission of this response indicates that static context transfer is complete.

While the second access point radio 204b receives the static context transfer 210, the first access point radio 204a can continue to communicate data with the wireless device. This can include the first access point radio 204a using a first link to communicate with the wireless device 202, e.g., with a first radio in the wireless device 202, while the second access point radio 204b uses a second link to communicate with the wireless device 202, e.g., with a second radio in the wireless device 202.

After time period T₀, the wireless device 202 can initiate the switch from the first access point radio 204a to the second access point radio 204b. This can include separately switching transmission of uplink data and receipt of downlink data. During the switch, the wireless device 202 can have a one point data flow switch for each direction, e.g., such that the wireless device 202 only receives downlink data from one access point radio at a time, only transmits uplink data to one access point radio at a time, or both.

As shown in FIG. 2, the wireless device initiates the switch from the first access point radio 204a to the second access point radio 204b separately for uplink data and downlink data. For instance, during time period T₁, the wireless device 202 initially transmits uplink data 214 to the first access point radio 204a. Then the wireless device 202 can stop transmitting the uplink data 214 to the first access point radio 204a and begin transmitting uplink data 216 to the second access point radio 204b.

After switching uplink transmission to the second access point radio 204b, e.g., during time period T₂ as shown in FIG. 2, the wireless device 202 continues to receive downlink data 218 from the first access point radio 204a. This can continue while the first access point radio 204a has downlink data buffered for the wireless device, e.g., such as the buffered downlink data 226. As noted below, this time period can overlap with one or more of the other time periods, can occur after another time period, or both.

During, e.g., at the beginning of, time period T₃, the network 206 completes a downlink route switch 220 for downlink data for the wireless device 202. This can include the network 206 updating a route for downlink data for the wireless device 202 to include the second access point radio 204b instead of the first access point radio 204a. For instance, the network 206 can remove the first access point radio 204a from the route and add the second access point radio 204b.

The network 206 sends downlink data 222 or a route update signal, or both, to the second access point radio 204b. For instance, the network 206 can send the first set of downlink data to the second access point radio 204b that the second access point radio 204b will receive for the wireless device 202. This can indicate to the second access point radio 204b that the second access point radio 204b is now on the downlink data route for the wireless device 202. In some implementations, the network 206 can send the route update signal to the second access point radio 204b. The route update signal can indicate that the second access point radio 204b is now on the downlink data route for the wireless device 202, e.g., when the network 206 does not have any downlink data to send to the wireless device 202 but the route has been updated. In some implementations, the network 206 can determine whether to send the downlink data or the route update signal depending on whether there is any downlink data for the wireless device 202 after the network 206 updated the route.

Upon receipt of the downlink data or the route update signal, the second access point radio 204b can transmit a downlink ready notification 224 to the wireless device 202. The downlink ready notification 224 can indicate that the second access point radio 204b is ready to transmit downlink data to the wireless device 202, e.g., after the wireless device 202 receives the last downlink data 226 from the first access point radio 204a.

The wireless device 202 determines whether it received the last downlink data 218, 226, e.g., for this session, from the first access point radio 204a. If not, the wireless device 202 can continue to receive downlink data 218, 226 from the first access point radio 204a. If so, the wireless device 202, during time period T₄, transmits a downlink transmission ready notification to the second access point radio 204b. In response, the second access point radio 204b transmits any downlink data 230 that is buffered at the second access point radio 204b. In some implementations, the second access point radio 204b might not have downlink data 230 buffered upon receipt of the downlink transmission ready notification. In these examples, the second access point radio 204b waits until receipt of downlink data from the network 206 to transmit the received downlink data to the wireless device 202.

One or more of the time periods can occur in different orders, overlap at least in part, e.g., operations for one of the time periods can be performed in parallel with operations for another time period, or a combination of both. For instance, the time period T₁ can overlap at least in part with the time period T₂, e.g., T₂ can include the entirety of T₁. In some implementations, T₁ can overlap at least in part with two or more of the time periods T₂, T₃, or T₄.

The wireless device 202 can transmit its instantaneous context data, e.g., carry the context sync, to the second access point radio 204b at any one or multiple appropriate times. For instance, as part of the downlink transmission ready notification 228, the wireless device 202 can transmit its instantaneous context data to the second access point radio 204b. The instantaneous context data can include context data with a change rate that satisfies the change rate threshold. The instantaneous context data can include a bitmap, one or more sequence numbers, other appropriate data, or any combination of two or more of these. In some implementations, the wireless device 202 might not need to transmit the instantaneous context data to the second access point radio 204b. In some implementations, the second access point radio 204b may seek, e.g., request, the latest downlink instantaneous context from the first access point radio 204a, e.g., after receiving downlink data or a route update signal.

In some implementations, the switch from the first access point radio 204a to the second access point radio 204b might not rely on the two access point radios 204a-b syncing in the middle of a data flow, signaling a synchronization complete, or both. For instance, the wireless device 202 can signal the synchronization complete by sending the data transmission ready notification, can sync the instantaneous context data with the second access point radio 204b, or both.

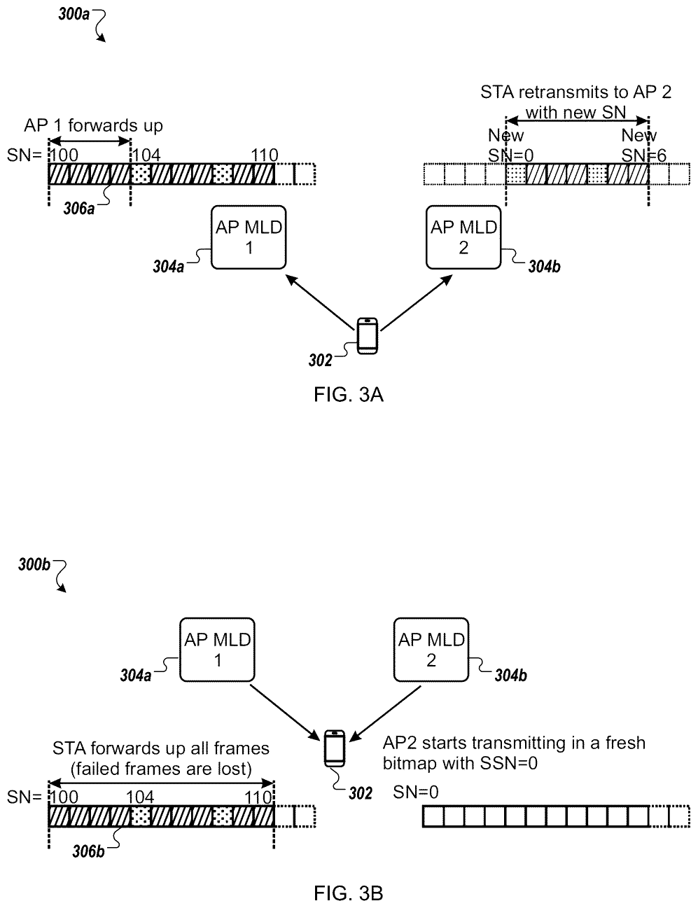

FIGS. 3A-B depict example environments 300a-b for a wireless device 302 switching communication between access point radios 304a-b given frame communication errors. Bitmaps 306a-b indicate sequence numbers (“SNs”) for corresponding frames. The boxes in the bitmaps 306a-b that have forward slashed lines indicate frames with corresponding sequence numbers, e.g., 104 and 108, that were not received successfully by a corresponding recipient device. The bitmaps 306a-b can be BA bitmaps.

In the environment 300a of FIG. 3A, the wireless device 302 is associated with a network that includes the access point radios 304a-b can perform an uplink route switch in the presence of frame receipt errors. For instance, a first access point radio 304a can successfully receive uplink frames for SN 100 through 103 up to a first lost frame 104, e.g., a first hole. The first access point radio 304a can optionally discard any remaining frames that it received. The first access point radio 304a can send a signal to the wireless device 302 that indicates the successfully received frames.

The wireless device 302 can maintain the uplink frames starting from the first frame that was lost, e.g., the first hole in the bitmap 306a. For instance, the wireless device 302 can maintain frames for SNs 104-110.

The wireless device 302 can determine, in response to receipt of the signal that indicates the successfully received frames, lost frames, or both, to send the remaining frames to the second access point radio 304b. The wireless device 302 can reassign the remaining frames to start from SN=0. Since there are seven remaining frames in FIG. 3A, these frames are assigned new SNs 0 to 6.

The wireless device 302 switches to the link with the second access point radio 304b, e.g., for uplink data. The wireless device 302 starts transmitting the remaining frames to the second access point radio 304b, beginning from the first hole in bitmap 306a, e.g., old SN=104 and new SN=0. This can be part of the process described above with respect to time period T₁ and the transition of transmitting uplink data to the second access point radio 204b, 304b, instead of the first access point radio 204a, 304a.

In the environment 300b of FIG. 3B, a network that includes the access point radios 304a-b can perform a downlink route switch in the presence of frame receipt errors. Since the network might not forward downlink data between access point radios, the wireless device 302 might remain on the link with the first access point radio 304a as long as possible to successfully receive remaining downlink frames from the first access point radio 304a.

The wireless device 302 can receive any appropriate amount of the remaining downlink frames from the first access point radio 304a. For example, the wireless device 302 can attempt to receive all remaining downlink frames buffered at the first access point radio 304a at least a predetermined quantity of times, e.g., one. This can enable the wireless device 302 to reduce downlink data loss while reducing the latency of the access point radio switch. For instance, the wireless device 302 might be roaming and determine that the wireless device 302 will likely have a better connection, e.g., lower data loss, by communicating with the second access point radio 304b instead of the first access point radio 304a. As a result, the wireless device 302 can attempt to receive all remaining buffered downlink data from the first access point radio 304a and then switch to the second access point radio 304b. In some implementations, because of this switch, any remaining failed or buffered downlink frames for the first access point radio 304a might be lost, e.g., because no MSDU transfer between access point radios.

The wireless device 302 can forward to the wireless device's 302 data stack all successfully received downlink frames from the bitmap 306b. This can include the wireless device 302 sending the successfully received downlink frames internally to the one or more applications that are using the received data.

All bitmap 306b sessions, e.g., BA sessions, are reset. For instance, the downlink BA session is reset for the communication between the wireless device 302 and the second access point radio 304b.

The wireless device 302 can signal the second access point radio 304b to begin transmitting downlink data to the wireless device 302. In response, the second access point radio 304b can begin transmitting downlink data to the wireless device with SN=0.

In some implementations, data communicated between the wireless device 302 and the access point radios 304a-b is encrypted. As part of the encryption process, a device can use a packet number (“PN”) and a transmitter address, e.g., an A2 field. The encryption process can use Galois/Counter Mode Protocol (“GCMP”). In some implementations, an encryption process can use the PN and the address to construct a nonce for encrypting the data. To improve security, and reduce a likelihood that the data will be decrypted by a malicious system, the combination of the PN and address values should always be different for each frame. As a result, when communicating with a radio that has a constant address, the PN value should always change, e.g., be increasing.

As part of the downlink switching process, the wireless device 302 or the first access point radio 304a can send PN data to the second access point radio 304b. For instance, the wireless device 302 can transmit, at the time of downlink path switch and to the second access point radio 304b, the last PN value the wireless device 302 received from the first access point radio 304a. The second access point radio 304b can then start its PN assignment with a value greater than the last PN value received from the wireless device 302.

In some implementations, e.g., during the offline context transfer of the pseudo-static context data, the first access point radio 304a can transmit its current PN value to the second access point radio 304b. The second access point radio 304b can increment the current PN value by a safely large margin, e.g., a predetermined value, to account for any remaining downlink transmissions from the first access point radio 304a to the wireless device 302 until downlink route update. The second access point radio 304b can then use the incremented PN value to start its PN assignment for downlink transmissions with the wireless device 302.

The value of the address can be any appropriate value. For instance, the address can be a multi-link multi-device (“MLMD”) address that remains the same between radios or a multi-link device (“MLD”) address that changes between radios. When the address value, e.g., A2 value, is an MLMD address, the nonce value will remain the same between the first access point radio 304a, e.g., origin AP MLD, and the second access point radio 304b, e.g., destination AP MLD, if the PN value does not change. As a result, when the environment 300a-b uses an MLMD address for the address value, the PN should not be reset to 0 by the second access point radio 304b, and the second access point radio 304b should maintain continuity of the PN values from those used by the first access point radio 304a. For instance, the second access point radio 304b can increment the PN values as described above.

When the address value is an MLD address, the nonce value will change at least because of the different MLD address for the first access point radio 304a and the second access point radio 304b, e.g., assuming that the radios are implemented in different access points and not the same access point. As a result, when the environment 300a-b uses MLD addresses, the second access point radio 304b can restart the PN space from zero.

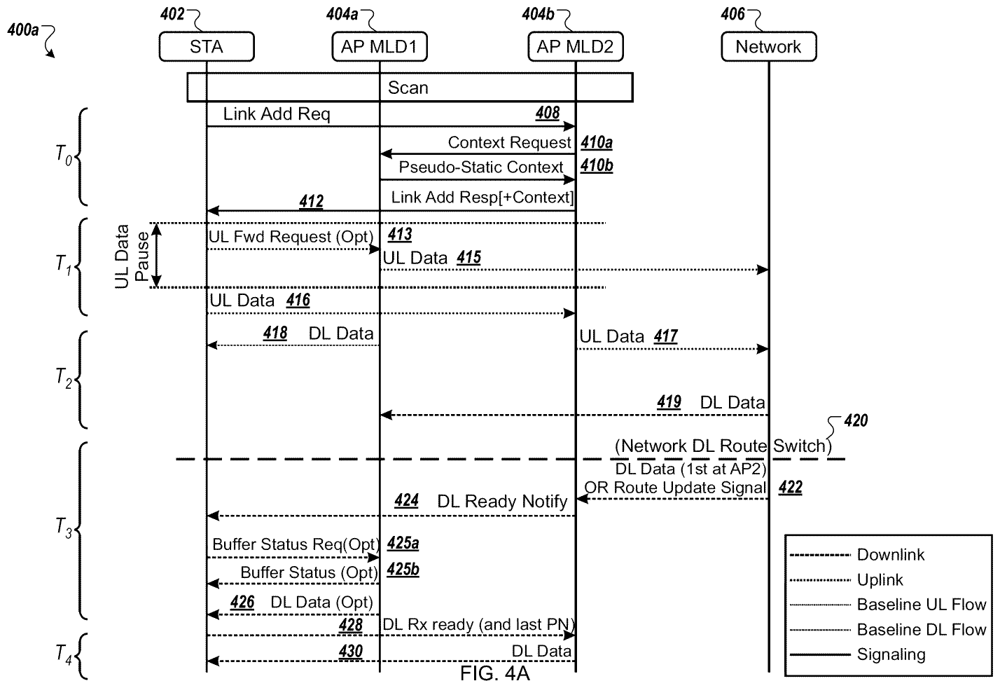

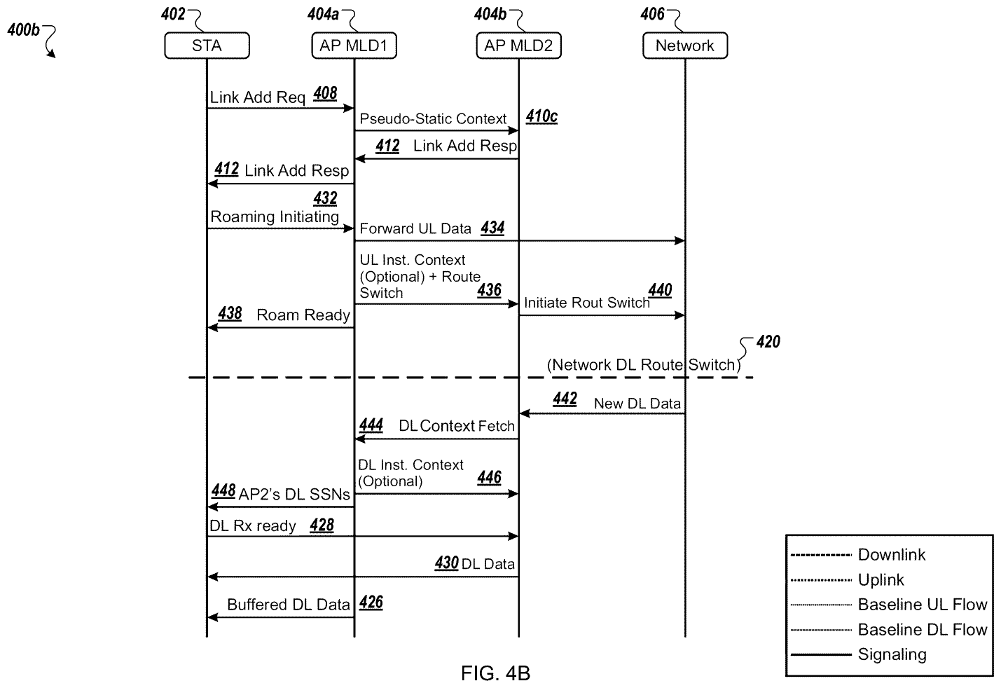

FIG. 4A depicts an example environment 400a in which a wireless device 402 communicates with two access point radios 404a-b. Unless otherwise noted, the various operations described with reference to the environment 400a are similar to the corresponding operation described with reference to the environment 200, described above.

For instance, during time period T₀, the wireless device 402 can transmit the link add request 408 or another initiation frame to the second access point radio 404b, e.g., a scanning and link add request or another appropriate type of request. In response, the second access point radio 404b can transmit a link add response 412 to the wireless device 402.

The second access point radio 404b can fetch, in response to receipt of the link add request 408, the wireless device's pseudo-static context data from the first access point radio 404a. This can include the second access point radio 404b transmitting a context request 410a to the first access point radio 404a. The second access point radio 404b can receive, in response, the wireless device's pseudo-static context data 410b as part of a context transfer. The pseudo-static context data 410b can include data for both uplink and downlink communications.

Prior to time period T₁, the wireless device 402 can transmit uplink data to the first access point radio 404a. The first access point radio 404a can transmit the uplink data 415 to a network 406, e.g., that includes the two access point radios 404a-b.

During time period T₁, the wireless device 402 can optionally transmit an uplink forward request 413 to the first access point radio 404a. The request can signal the first access point radio 404a to forward uplink data 415 up to a location in a bitmap, e.g., a BA bitmap or scoreboard. The location can be a first hole in the bitmap. The request can signal the first access point radio 404a to forward all uplink data 415. In some implementations, the first access point may be instructed, e.g., by the wireless device 402, to initiate network route switch after receiving this request.

The wireless device 402 can then switch the uplink path to the second access point radio 404b. For example, the wireless device 402 can transmit uplink data 416 to the second access point radio 404b. For the uplink data 416, the wireless device can reset SN=0 while continuing PN from the prior values used for transmitting uplink data to the first access point radio 404a. The second access point radio 404b can transmit the uplink data 417 to the network 406, e.g., after time period T₁.

In some implementations, the wireless device 402 can transmit, to the second access point radio, gratuitous address resolution protocol (“GARP”) data, e.g., if necessary for the uplink path switch.

During time period T₂, the wireless device 402 receives downlink data 418 from the first access point radio 404a. The first access point radio 404a can continue to receive downlink data 419 from the network, e.g., after the wireless device 402 began transmitting the uplink data 416 to the second access point radio 404b, after the second access point radio 404b transmits the uplink data to the network 406, or both.

During time period T₃, the network 406 downlink route switch 420 completes. The second access point radio 404b can wait for the first downlink frame 422 from the network, receive a route update notification from the network 406, or both. In response to receipt of either, the second access point radio 404b can notify 424 the wireless device 402 that the downlink route now includes the second access point radio 404b instead of the first access point radio 404a. In some implementations, the second access point radio 404b can retrieve latest downlink instantaneous state from the first access point radio 404a during time period T₃.

The wireless device 402 can optionally transmit a buffer status request 425a to the first access point radio 404a. In response, the first access point radio 404a can transmit, to the wireless device 402, a buffer status 425b.

The wireless device 402 can optionally transmit a request to the first access point radio 404a to receive information about the remaining data buffered at the first access point radio 404a. This request can be part of the buffer status request 425a or a separate request. In some implementations, the buffer status request 425a can indicate a request for the remaining buffered data 426.

The wireless device 402 can continue to receive downlink data from the first access point radio 404a until one or more criteria are satisfied. For instance, the wireless device 402 can receive downlink data until a frame includes a “MoreData” bit with a value of zero. The one or more criteria can include any other appropriate deadline, e.g., to reduce latency for the switch, link quality target, other appropriate criteria, or a combination of these.

In some implementations, the wireless device 402 can request to discard data for some TIDs. For instance, the wireless device 402 can receive only low-latency downlink data during this transition period.

During time period T₄, the wireless device 402 can transmit a downlink transmission ready message 428 to the second access point radio 404b. For example, the wireless device 402 can forward, to the second access point radio 404b, instantaneous context data for its communications with the first access point radio 404a. The instantaneous context data can include a last PN for downlink data received from the first access point radio 404a. The instantaneous context data can include context data for everything the wireless device 402 received from the first access point radio 404a, e.g., including holes in between the bitmaps. In some implementations, the wireless device 402 can transmit, to the second access point radio 404b, the downlink transmission ready message 428 separately from the instantaneous context data.

The second access point radio 404b can transmit downlink data 430 to the wireless device 402. The downlink transmission can begin with SN-0 and continue with PN values given the prior PN values used for downlink transmission from the first access point radio 404a.

The environment 400a, e.g., the wireless device 402 and one or both of the access point radios 404a-b, can use any appropriate process for signaling between the devices. For instance, the signaling can indicate that the wireless device 402 operates on a first link, e.g., 5 GHz, with the first access point radio 404a while another link between the two, e.g., 6 GHz, is disabled or in sleep mode, while the active links are switched with the second access point radio 404b, e.g., the 5 GHz link between the wireless device 402 and the second access point radio 404b is disabled or in sleep mode while the 6 GHz link is active.

For eMLSR mode, during roaming, the wireless device 402 can operate two single-link eMLSRs, one with each of the access point radios 404a-b. In these examples, the single-link eMLSRs can use an ICF to initiate each downlink transmission opportunity (“TXOP”) from either of the two access point radios 404a-b. In some implementations, neighboring access point radios 404a-b can be expected to be on a different channel on each band.

In some implementations, at, after, or a combination of both, the environment 400a can use EML-OMN to enable eMLSR on the second access point radio 404b.

In some implementations, at, after, or a combination of both, the environment 400a can use PM=1 on the second access point radio 404b link, and PM=1 on the other first access point radio 404a link.

One or more of the time periods can overlap at least in part, e.g., operations for one of the time periods can be performed in parallel with operations for another time period.

FIG. 4B depicts another example environment 400b in which the wireless device 402 communicates with two access point radios 404a-b. Unless otherwise noted, the various operations described with reference to the environment 400b are similar to the corresponding operations described with reference to one or both of the environments 200 or 400a, described above.

In the environment 400b, instead of transmitting the pseudo-static context data 410b that can include data for both uplink and downlink communications, the first access point radio 404a transmits pseudo-static context data 410c that includes data for only uplink communications. As described in more detail below, the first access point radio 404a later transmits the downlink instantaneous context 446 after the downlink route switch 420 completes.

The wireless device 402 can transmit a roaming initiation signal 432 to the first access point radio 404a. In response, the first access point radio 404a can forward any remaining uplink data on the first access point radio 404a to the network 406.

The first access point radio 404a can request 436 the second access point radio to switch a data path. The first access point radio 404a can optionally transmit the instantaneous uplink context data 436 to the second access point radio 404b, e.g., when the uplink context data has changed from the data transmitted at 410c. For instance, the first access point radio 404a can transmit the instantaneous uplink context data 436 if the uplink sequence number is not reset. If the uplink sequence number is reset, the first access point radio 404a can determine to skip transmitting the instantaneous uplink context data 436.

The first access point radio 404a can transmit, to the wireless device 402, a roaming ready message 438.

The second access point radio 404b can initiate, with the network 406, a route switch 440.

After the downlink route switch 420, the network 406 can transmit, to the second access point radio 404b, new downlink data. The second access point radio 404b can fetch, from the first access point radio 404a, the instantaneous downlink context 444. This fetch can occur in response to the network route switch, e.g., because the first access point radio 404a does not receive a notification of the route switch.

In response to the fetch, the first access point radio 404a can transmit, to the second access point radio 404b, the downlink instantaneous context 446. This can include the first access point radio 404a computing the last downlink sequence number, e.g., because the first access point radio 404a does not have any additional downlink data arriving in its queues. The first access point radio 404a can transmit the last downlink sequence number to the second access point radio 404b.

The second access point radio 404b can determine to wait to transmit any downlink data to the wireless device 402 until it receives the instantaneous downlink context from the first access point radio 404a, or determines to reset the downlink sequence number. The second access point radio 404b can determine to reset the downlink sequence number in any appropriate manner, e.g., upon receipt of a message from the first access point radio 404a or the network 406 that the sequence number should be reset.

In some implementations, when the first access point radio 404a transmits, to the second access point radio 404b, one or more downlink sequence numbers, the first access point radio 404a can transmit the one or more downlink sequence numbers to the wireless device 402. The wireless device 402 can use the one or more downlink sequence numbers to determine when, how, or both, to start downlink retrieval from the second access point radio 404b.

In some implementations, the wireless device 402 can transmit, to the second access point radio 404b, a start downlink signal (not shown). This can occur when the one or more downlink sequence numbers for the second access point radio 404b do not fit in the current BA window.

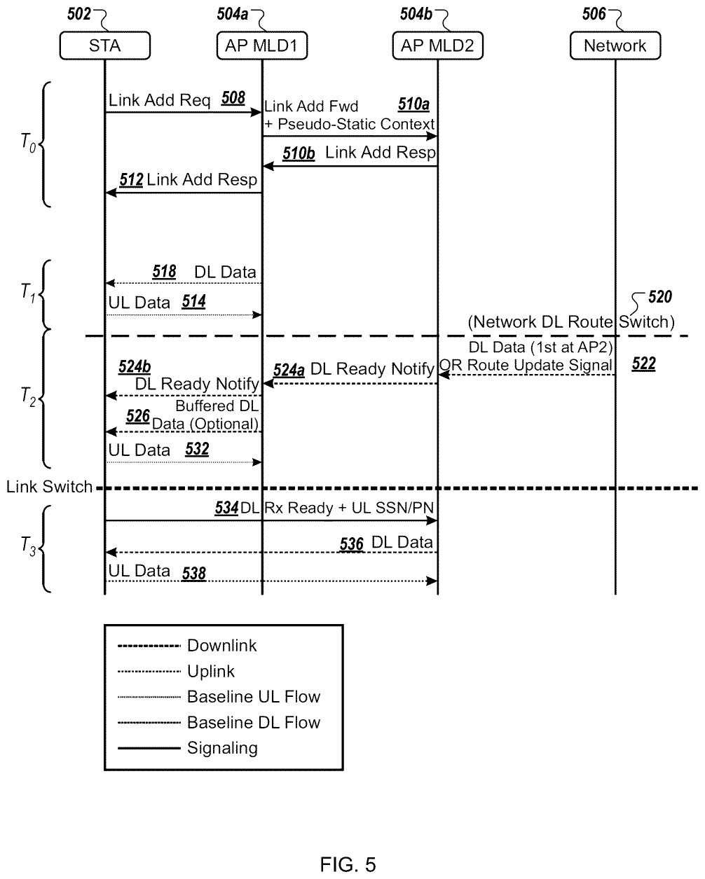

FIG. 5 depicts an example environment 500 in which a single radio wireless device 502 communicates with two access point radios 504a-b. Unless otherwise noted, the various operations described with reference to the environment 500 are similar to the corresponding operation described with reference to the environment 200 and the environments 400a-b, described above.

In the environment 500, the various devices and systems can minimize the number of channel switches required by the wireless device 502, e.g., to reduce an overall latency of the wireless device's 502 switch from a first access point radio 504a to a second access point radio 504b in a network 506. In some implementations, the wireless device 502 has verified the uplink, downlink, or both, reachability with the second access point radio 504b before performing the operations described with reference to FIG. 5.

During time period T₀, the wireless device 502 can perform one or more link add operations 508, 510a-b, and 512. For instance, the wireless device can transmit a link add request 408 to the first access point radio 504a. The first access point radio 504a can forward the request 510a, along with the wireless device's pseudo-static context data, to the second access point radio 504b. The first access point radio 504a can receive a link add response 510b from the second access point radio 504b and forward the received response 512 to the wireless device. By routing the requests and responses through the first access point radio 504a, the number of switches by the wireless device 502 are reduced, latency of switching to the second access point radio 504b is reduced, or both.

Since the environment 500 reduces the number of channel switches for the wireless device 502, the downlink and uplink switch will occur substantially concurrently after downlink buffer retrieval. For instance, the switch will occur after the first access point radio 504a finishes transmitting downlink data 526 to the wireless device 502. As a result, during time period T₁, the wireless device 502 continues to receive downlink data 518 from, and transmit uplink data 514 to, the first access point radio.

After the network route switch 520 during time period T₂, the network 506 transmits the first downlink frame 522, a route update notification, or both, to the second access point radio 504b. To reduce channel switching, latency, or both, the second access point radio 504b forwards a downlink ready notification 524a to the first access point radio 504a. The first access point radio 504a forward the downlink ready notification 524b to the wireless device 502.

Although the second access point radio 504b is ready to transmit downlink data to the wireless device 502, the first access point radio 504a might still have buffered downlink data 526 for the wireless device 502. If so, the wireless device 502 can determine whether to maintain the link with the first access point radio 504a to receive the rest of the data. The first access point radio 504a optionally transmits the buffered downlink data 526 to the wireless device.

During this time period T₂, the wireless device 502 can continue to transmit uplink data 532 to the first access point radio 504a. The wireless device 502 might not be able to transmit uplink data to the first access point radio 504a during time period T₂, e.g., because of a network route. If so, the network 506 can switch back to the first access point radio 504a for the downlink data route.

Once the first access point radio 504a finishes transmitting downlink data to the wireless device 502, the wireless device 502 can transmit a downlink transmission ready message 534 to the second access point radio 504b during time period T₃. The wireless device 502 can then receive downlink data 536 from, and transmit uplink data 538 to, the second access point radio 504b.

In some implementations, an optional GARP transmission can require a pair of link switches after transmission of the link add response 512. If the wireless device 502 has a sustainable link with the first access point radio 504a, the GARP transmission likely will not be required.

One or more of the time periods can overlap at least in part, e.g., operations for one of the time periods can be performed in parallel with operations for another time period.

In some implementations, whether for a single radio or multi-radio wireless device, the access point radios can transfer a complete context for the wireless device, e.g., including BA bitmap, SN, PN, or a combination of these. In this sequence, the wireless device can pause transfer, e.g., all transfer, for the duration of the context transfer between access point radios. After the context transfer, both downlink and uplink paths can be switched to the second access point radio. Compared with the other sequences described in this specification, this sequence might cause latency due to the pause, downlink data loss, or both.

In some implementations, the wireless device and both access point radios can agree on a future time, e.g., within a time period threshold, for a data path switch to occur. A similar pause can be required, as described above, while context is transferred.

In some implementations, the environment 200 or the environments 400a-b can include one or more of the following optional features. The wireless device can tear down all existing BA sessions with the first access point radio for the duration of the roam. The wireless device can setup new BA sessions on the second access point radio.

The wireless device can initiate link add with either the destination second access point radio or the origin first access point radio. When the wireless device initiates the link add with the origin first access point radio, the first access point radio forwards the request to the second access point radio.

The wireless device can initiate the context transfer by sending a request to both access point radios. This can include requesting the first access point radio to initiate context transfer and requesting the second access point radio to add links. This can reduce latency compared to some other systems.

The second access point radio can wait for the first downlink data frame to notify the wireless device of a downlink route update. In some implementations, the network may send a signal to one or both of the access point radios to notify them about the route update. One or both of the two access point radios can then notify the wireless device. When the network sends the signal to the access point radios, at least one of which notifies the wireless device, the wireless device can receive an earlier signal to switch fully to the second access point radio compared to other systems.

After receiving a downlink route update notification, the wireless device can wait for a downlink frame from the first access point radio and stay on the first access point radio link until a downlink frame is received with a “MoreData” bit=0.

One or more of the above described operations include transmission of various types of data. In some implementations, when at least part of the operations are performed by a processor, the operation can include generation of instructions for transmission of the data. The processor can provide the instructions to another component in the device, e.g., a transmitter, to cause the transmitter to transmit the data. The other component, e.g., the transmitter, can be an optional component in an apparatus, the operations performed by the transmitter, e.g., the actual data transmission, can be optional, or a combination of both.

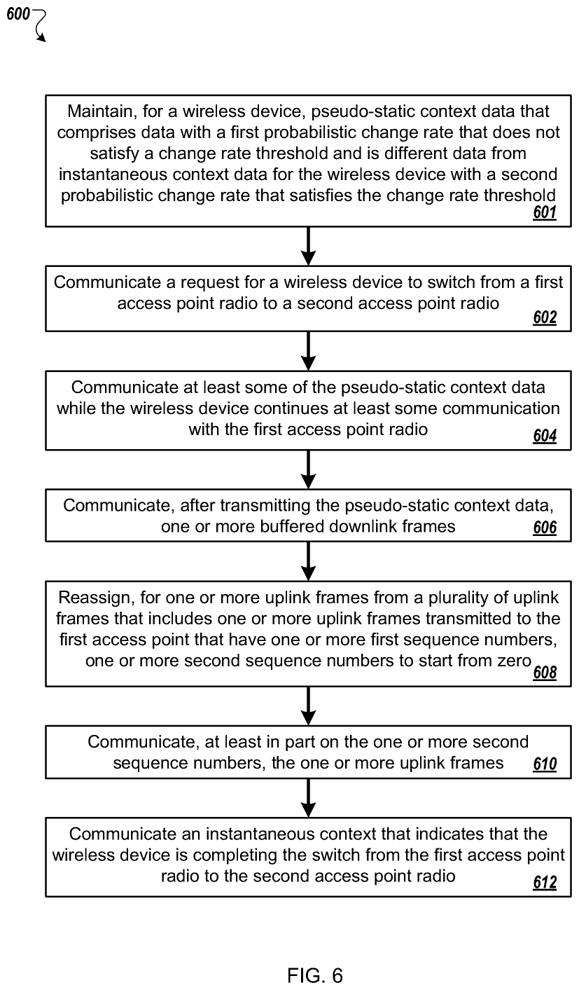

FIG. 6 illustrates a flowchart of an example method 600 for using pseudo-static context data, according to some implementations. For clarity of presentation, the description that follows generally describes method 600 in the context of the other figures in this description. For example, method 600 can be performed by a combination of the wireless device and the access point radios of FIGS. 2, 4, and 5. Although the operations in the method 600 are sometimes described as data being communicated between two different devices, this operation can include transmitting by one device, or receiving by another device, or generating instructions for the transmission or receipt of data.

It will be understood that method 600 can be performed, for example, by any suitable system, environment, software, hardware, or a combination of systems, environments, software, and hardware, as appropriate. In some implementations, various operations of method 600 can be run in parallel, in combination, in loops, or in any order.

A device maintains, for a wireless device, pseudo-static context data that comprises data with a first probabilistic change rate that does not satisfy a change rate threshold and is different data from instantaneous context data for the wireless device with a second probabilistic change rate that satisfies the change rate threshold (601). The device can maintain the pseudo-static context data in any appropriate location, e.g., in memory or in a database implemented in memory.

The first change rate, the second change rate, or both, might change over time. The change rates are probabilistic because the device might not necessarily know the exact change rate at any particular time, but might know that the pseudo-static context data generally changes by first amount that is approximately the first change rate and that the instantaneous context data, whether uplink, downlink, or both, changes by a second amount that is approximately the second change rate.

For instance, when the pseudo-static context data includes one or more block acknowledgement parameters for a session between the first access point radio and the wireless device, the device might not know the specific first rate at which those parameters change but know that those parameters change at a rate that does not satisfy the change rate threshold, e.g., falls within a first change rate range that does not satisfy the change rate threshold. When the instantaneous context data includes a sequence number, the device might not know the specific second rate at which the sequence numbers change but know that the sequence numbers change at a rate that satisfies the change rate threshold, or satisfies the change rate threshold at least a threshold amount of time. In these examples, the second change rate might fall within a second change rate range that satisfies the change rate threshold.

In some implementations, the device can maintain the instantaneous context data in memory. The instantaneous context data can be maintained in the same memory or different memory from that which maintains the pseudo-static context data.

The device communicates a request for the wireless device to switch from a first access point radio to a second access point radio (602). This can include the device generating instructions for transmission of a message that indicates the switch from the first access point radio to the second access point radio. The device, e.g., a processor, can send the instructions to a communication resource, e.g., a transmitter, to cause the communication resource to transmit the message, e.g., to the network, the second access point radio, the first access point radio, or any combination of these, in part based on component that is transmitting the message.

A device communicates at least some of the pseudo-static context data while the wireless device continues at least some communication with the first access point radio. For instance, the device retrieves some of the exiting pseudo-static context data that is maintained in the memory.

In some implementations, the device can select at least some of the pseudo-static context data for transmission, e.g., from the memory. The device can generate instructions for the transmission of the selected pseudo-static context data to the second access point radio. The device can send the instructions to another component, e.g., communication resource.

A device communicates, after transmitting the pseudo-static context data, one or more buffered downlink frames (606).

A device reassigns, for one or more uplink frames from a plurality of uplink frames that includes one or more uplink frames transmitted to the first access point that have one or more first sequence numbers, one or more second sequence numbers to start from zero (608).

A device communicates, based at least in part on the one or more second sequence numbers, the one or more uplink frames (610).

A device communicates an instantaneous context that indicates that the wireless device is completing the switch from the first access point radio to the second access point radio (612).

In some implementations, the device can either reassign the one or more second sequence numbers to start from zero or communicate the instantaneous context, but not both. For instance, by reassigning a sequence number, a system can more quickly switch from a first access point radio to a second access point radio because the system need not wait for transmission of the instantaneous context data. By transmitting instantaneous context data, a system can increase a likelihood that all data is transmitted to the wireless device because the wireless device can request retransmission of data when data is not received for any particular sequence number. In some implementations, by transmitting instantaneous context data, a system can more easily implement one or more of the describe operations than other systems.

The description of communication of various forms of data, whether pseudo-static context data, instantaneous context, or other types of data, can include the generation of instructions to cause transmission or other forms of communication of the respective types of data.

In this specification, the term “likely” is used to mean that there is a likelihood that something might occur and that likelihood satisfies a likelihood threshold. For instance, when determining whether one value is likely greater than another, and those values are floating point numbers, a system would determine a likelihood that the one value is greater than the other value. The system would then determine whether the likelihood satisfies, e.g., is greater than or equal to, a likelihood threshold by comparing the two likelihoods. If so, the system determines that the one value is likely greater than the other value. If not, the system determines that the one value is not likely greater than the other value.

The example method 600 shown in FIG. 6 can be modified or reconfigured to include additional, fewer, or different operations (not shown in FIG. 6), which can be performed in the order shown or in a different order. In some implementations, the method 600, e.g., as performed by the wireless device, can include operations 602, 608, 610, and 612, or a subset of these, without the other operations. The method 600, e.g., as performed by the first access point radio, can include operations 602, 604, and 606, or a subset of these, without the other operations. The method 600, e.g., as performed by the second access point radio, can include operations 602, 604, 610, and 612, or a subset of these, without the other operations.

FIG. 7 illustrates a block diagram of an electronic device 700, according to some implementations. The electronic device 700 can be a cellular telephone, a smartwatch, an access point, a wireless speaker, an Internet-of-Things (IoT) device, among other examples. The electronic device 700 includes hardware resources 702 that include one or more processors (or processor cores) 710, one or more memory/storage devices 720, and one or more communication resources 730, each of which can be communicatively coupled via a bus 740.

The one or more processors 710 include one or more devices configured to perform computational operations. For example, the one or more processors 710 can include one or more microprocessors, application-specific integrated circuits (ASICs), microcontrollers, graphics processing units (GPUs), programmable-logic devices, and/or one or more digital signal processors (DSPs). The processors 710 can include, for example, a processor 712 and a processor 714. The processor(s) 710 can be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 720 can include main memory, disk storage, or any suitable combination thereof. The memory/storage devices 720 can include, but are not limited to, any type of volatile or nonvolatile memory such as dynamic random-access memory (DRAM), static random-access memory (SRAM), erasable programmable read-only memory (EPROM), electrically erasable programmable read-only memory (EEPROM), Flash memory, solid-state storage, etc. In some implementations, the memory/storage devices 720 are coupled to one or more high-capacity mass-storage devices (not shown). In some implementations, memory/storage devices 720 can be coupled to a magnetic or optical drive, a solid-state drive, or another type of mass-storage device. In these examples, the memory/storage devices 720 can be used by electronic device 700 as fast-access storage for often-used data, while the mass-storage device is used to store less frequently used data.

The communication resources 730 can include interconnection or network interface components or other suitable devices to communicate with one or more peripheral devices 704 or one or more databases 706 via a network 708. For example, the communication resources 730 can include wired communication components (e.g., for coupling via USB), cellular communication components, NFC components, Bluetooth® (or Bluetooth® Low Energy) components, Wi-Fi® components, and other communication components.

The communication resources 730 include one or more devices configured to couple to and communicate on a wired and/or wireless network (i.e., to perform network operations), such as: control logic, one or more interface circuits and a set of antennas (or antenna elements) in an adaptive array that can be selectively turned on and/or off by control logic to create a variety of optional antenna patterns or “beam patterns.” Alternatively, instead of the set of antennas, in some implementations, electronic device 700 includes one or more nodes, e.g., a pad or a connector, which can be coupled to the set of antennas. Thus, electronic device 700 might or might not include the set of antennas. For example, communication resources 730 can include a Bluetooth™ networking system, a cellular networking system (e.g., a 3G/4G/5G/6G network such as UMTS, LTE, etc.), a universal serial bus (USB) networking system, a networking system based on the standards described in IEEE 802.11 (e.g., a Wi-Fi® networking system), an Ethernet networking system, and/or another networking system.

In some implementations, communication resources 730 includes one or more radios, such as a wake-up radio that is used to receive wake-up frames and wake-up beacons, and a main radio that is used to transmit and/or receive frames or packets during a normal operation mode. The wake-up radio and the main radio can be implemented separately (such as using discrete components or separate integrated circuits) or in a common integrated circuit.

The communication resources 730 include processors, controllers, radios/antennas, sockets/plugs, and/or other devices used for coupling to, communicating on, and handling data and events for each supported networking system. Note that mechanisms used for coupling to, communicating on, and handling data and events on the network for a network system are sometimes collectively referred to as a “network interface” for the network system.

Instructions 750 can comprise software, a program, an application, an applet, an app, or other executable code for causing at least any of the processors 710 to perform any one or more of the methodologies discussed herein. The instructions 750 can reside, completely or partially, within at least one of the processors 710 (e.g., within the processor's cache memory), the memory/storage devices 720, or any suitable combination thereof. In some implementations, any portion of the instructions 750 can be transferred to the hardware resources 702 from any combination of the peripheral devices 704 or the databases 706. Accordingly, the memory of processors 710, the memory/storage devices 720, the peripheral devices 704, and the databases 706 are examples of computer-readable and machine-readable media.

While the preceding discussion used a Wi-Fi communication protocol as an illustrative example, in other implementations a wide variety of communication protocols and, more generally, wireless communication techniques can be used. Thus, the communication techniques can be used in a variety of network interfaces. Furthermore, while some of the operations in the preceding implementations were implemented in hardware or software, in general the operations in the preceding implementations can be implemented in a wide variety of configurations and architectures. Therefore, some or all of the operations in the preceding implementations can be performed in hardware, in software or a combination of both. For example, at least some of the operations in the communication techniques can be implemented using instructions 750, operating system (such as a driver for an interface circuit in communication resources 730) or in firmware in an interface circuit in communication resources 730. Additionally or alternatively, at least some of the operations in the communication techniques can be implemented in a physical layer, such as hardware in an interface circuit in communication resources 730. In some implementations, the communication techniques are implemented, at least in part, in a MAC layer and/or in a physical layer in an interface circuit in communication resources 730.

While the preceding implementations illustrated the use of wireless signals in one or more bands of frequencies, in some implementations, electromagnetic signals in one or more different frequency bands are used to determine the range. For example, these signals can be communicated in one or more bands of frequencies, including: a microwave frequency band, a radar frequency band, 900 MHZ, 2.4 GHz, 5 GHz, 6 GHz, 60 GHz, and/or a band of frequencies used by a Citizens Broadband Radio Service, by LTE, 5G, or any other communication system.

Although specific components are used to describe electronic device 700, in some implementations, different components and/or subsystems can be present in electronic device 700. For example, electronic device 700 can include one or more additional processing subsystems, memory subsystems, networking subsystems, and/or display subsystems. Additionally, one or more of the subsystems might not be present in electronic device 700. In some implementations, electronic device 700 can include one or more additional subsystems that are not shown in FIG. 7. In some implementations, electronic device can include an analysis subsystem that performs at least some of the operations in the communication techniques. Although separate subsystems are shown in FIG. 7, in some implementations some or all of a given subsystem or component can be integrated into one or more of the other subsystems or component(s) in electronic device 700.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. A method comprising:
maintaining, for a wireless device, pseudo-static context data that comprises data with a first probabilistic change rate that does not satisfy a change rate threshold and is different data from instantaneous context data for the wireless device with a second probabilistic change rate that satisfies the change rate threshold;
determining that the wireless device will switch from a first access point radio to a second access point radio;
selecting at least some of the pseudo-static context data for the wireless device communication with the first access point radio based at least on determining that the wireless device will switch from the first access point radio to the second access point radio; and
generating instructions for transmission, to the second access point radio while the wireless device continues at least some communication with the first access point radio, of the at least some of the pseudo-static context data.

2. The method of claim 1, wherein determining that a wireless device will switch from a first access point radio to a second access point radio comprises receiving, from the wireless device, a request to switch from the first access point radio to the second access point radio.

3. The method of claim 1, comprising generating second instructions for transmission, to the wireless device and after transmitting the pseudo-static context data, of one or more downlink frames.

4. The method of claim 3, comprising:
receiving, from the wireless device, a request for a buffer status after a network downlink route switch from the first access point radio to the second access point radio; and
generating third instructions for transmission, to the wireless device, of a response that represents a quantity of buffered downlink frames remaining at the first access point radio.

5. The method of claim 3, comprising updating a more data bit in the one or more buffered downlink frames to indicate that the first access point radio does not have additional buffered downlink frames and the wireless device should signal the second access point radio to start transmitting downlink frames to the wireless device.

6. The method of claim 5, wherein the more data bit is in a last buffered downlink frame.

7. The method of claim 1, comprising determining, at the time that the wireless device is completing the switch from the first access point radio to the second access point radio, whether to generate second instructions for the transmission of the instantaneous context to the second access point radio.

8. The method of claim 1, comprises generating second instructions for the transmission, to the second access point radio before completing the switch from the first access point radio to the second access point radio, of an uplink instantaneous context.

9. The method of claim 1, comprises generating second instructions for the transmission, to the second access point radio after completing the switch from the first access point radio to the second access point radio, of a downlink instantaneous context.

10. The method of claim 1, wherein the first access point radio and the second access point radio are separately located access points.

11. A method comprising:
receiving, from a first access point radio and by a second access point radio and while a wireless device continues at least some communication with the first access point radio, pseudo-static context data that indicates that the wireless device will switch from the first access point radio to the second access point radio; and
receiving, from the wireless device or the first access point radio, an instantaneous context at the time that the wireless device is completing the switch from the first access point radio to the second access point radio.

12. The method of claim 11, wherein the instantaneous context comprises an explicit instantaneous context or an implicit instantaneous context.

13. The method of claim 11, comprising:
determining, based at least on the instantaneous context, a packet number for transmissions to the wireless device; and
generating instructions for transmission, based at least on the packet number, of one or more downlink frames to the wireless device.

14. The method of claim 11, comprising:
determining, based at least on the pseudo-static context data, a packet number for transmissions to the wireless device; and
generating instructions for transmission, based at least on the packet number, of one or more downlink frames to the wireless device.

15. The method of claim 11, wherein receiving the pseudo-static context data comprises receiving the pseudo-static context data from the first access point radio with a first multi-link device address and by the second access point radio with a second, different multi-link device address, the method comprising:
resetting a packet number for transmissions to the wireless device; and
generating instructions for transmission, based at least on the packet number and the second, of different multi-link device address, one or more downlink frames to the wireless device.

16. The method of claim 11, wherein the first access point radio and the second access point radio are separately located access points.

17. A method comprising:
generating instructions for transmission, from a wireless device, of a request to switch from a first access point radio to a second access point radio and that indicates that the first access point radio should transmit, to the second access point radio, pseudo-static context data for the wireless device communication with the first access point radio;
reassigning, for one or more uplink frames from a plurality of uplink frames that includes one or more uplink frames transmitted to the first access point radio that have one or more first sequence numbers, one or more second sequence numbers to start from zero; and
generating second instructions for transmission, to the second access point radio and based at least in part on the one or more second sequence numbers, of the one or more uplink frames.

18. The method of claim 17, comprising:
maintaining, in an uplink bitmap, the one or more first sequence numbers for the one or more uplink frames transmitted to the first access point radio; and
selecting, as a first uplink frame in the one or more uplink frames, a frame represented by a first hole in the uplink bitmap.

19. The method of claim 18, wherein:
a last uplink frame from the one or more uplink frames has a first packet number; and
generating the second instructions for transmission of the one or more uplink frames comprises generating the second instructions for transmission of the one or more uplink frames, the first of which has a second packet number that maintains packet number continuity based on the first packet number.

20. The method of claim 19, wherein the second packet number is the next packet number, sequentially, after the first packet number.
